(19) United States
(12) Patent Application Publication
(10) Pub. No.: US 2021/0125516 A1
(43) Pub. Date: Apr. 29, 2021

(54) ANSWER TRAINING DEVICE, ANSWER TRAINING METHOD, ANSWER GENERATION DEVICE, ANSWER GENERATION METHOD, AND PROGRAM

(71) Applicant: NIPPON TELEGRAPH AND TELEPHONE CORPORATION, Tokyo (JP)

(72) Inventors: Kosuke NISHIDA, Tokyo (JP); Kyosuke NISHIDA, Tokyo (JP); Atsushi OTSUKA, Tokyo (JP); Itsumi SAITO, Tokyo (JP); Hisako ASANO, Tokyo (JP); Junji TOMITA, Tokyo (JP)

(73) Assignee: NIPPON TELEGRAPH AND TELEPHONE CORPORATION, Tokyo (JP)

(21) Appl. No.: 17/254,187

(22) PCT Filed: Jun. 14, 2019
(86) PCT No.: PCT/JP2019/023755

§ 371 Date: Dec. 18, 2020

(30) Foreign Application Priority Data
Jun. 18, 2018 (JP) 2018-115166
Feb. 25, 2019 (JP) 2019-032127

(51) Int. Cl. G09B 17/00; G06N 20/00; G06N 3/04

(52) U.S. Cl. CPC G09B 17/003; G06N 3/04; G06N 20/00

(57) ABSTRACT

A question that can be answered with polarity can be accurately answered with polarity. A machine comprehension unit 210 estimates the start and the end of a range serving as a basis for an answer to the question in text by using a reading comprehension model trained in advance to estimate the range based on the inputted text and question. A determination unit 220 determines the polarity of the answer to the question by using a determination model trained in advance to determine whether the polarity of the answer to the question is positive or not based on information obtained by the processing of the machine comprehension unit 210.

### TECHNICAL FIELD

The present invention relates to an answer learning apparatus, an answer learning method, an answer generating apparatus, an answer generating method, and a program and particularly relates to an answer generating apparatus, an answer learning apparatus, an answer generating method, an answer learning method, and a program, for answering a question with polarity.

### BACKGROUND ART

A machine comprehension technique (for example, BiDAF (NPL 1)) in which a machine reads a text to answer a question has received attention in recent years. SQuAD (NPL 2) exists as a typical data set for machine comprehension, and enables a large-scale deep learning technique to be applied.

SQuAD is a data set for an extractive task in which a text in one paragraph is associated with a question and an answer written in the text is extracted as an answer to the question.

### CITATION LIST

### Non Patent Literature

[NPL1] Minjoon Seo, Aniruddha Kembhavi, Ali Farhadi, Hananneh Hajishirzi, “BI-DIRECTIONAL ATTENTION FLOW FOR MACHINE COMPREHENSION”, Published as a conference paper at ICLR, 2017.
[NPL2] Pranav Rajpurkar, Jian Zhang, Konstantin Lopyrev, Percy Liang, “SQuAD: 100,000+ Questions for Machine Comprehension of Text”, Computer Science Department Stanford University, 2016.

### SUMMARY OF THE INVENTION

### Technical Problem

Unfortunately, there is a problem such that a technique for an extractive task cannot output an answer in a format unwritten in a text. Specifically, to a question that can be answered with polarity of Yes or No, an answer with the polarity (Yes or No) cannot be made. In order to output an answer in a format unwritten in a text, it is necessary for a machine to determine an answer to a question from a part related to the question as well as focus on the related part in the text.

The present invention has been devised in view of above problem. An object of the present invention is to provide an answer generating apparatus, an answer generating method, and a program, which can make an accurate answer with polarity to a question that can be answered with polarity.

The present invention has been devised in view of the problem. Another object of the present invention is to provide an answer learning apparatus, an answer learning method, and a program, which can learn a model for making an accurate answer with polarity to a question that can be answered with polarity.

### Means for Solving the Problem

An answer generating apparatus according to the present invention includes a machine comprehension unit that estimates the start and the end of a range serving as a basis for an answer to a question in a text, by using a reading comprehension model trained in advance to estimate the range based on the inputted text and question, and a determination unit that determines the polarity of the answer to the question by using a determination model trained in advance to determine whether the polarity of the answer to the question is positive or not based on information obtained by the processing of the machine comprehension unit.

An answer generation method according to the present invention includes: the method in which the machine comprehension unit estimates the start and the end of the range serving as a basis for an answer to the question in the text by using the reading comprehension model trained in advance to estimate the range based on the inputted text and question, and the determination unit determines the polarity of the answer to the question by using the determination model trained in advance to determine whether the polarity of the answer to the question is positive or not based on the information obtained by the processing of the machine comprehension unit.

According to the answer generating apparatus and the answer generation method of the present invention, the machine comprehension unit estimates the start and the end of the range serving as a basis for an answer to the question in the text, by using the reading comprehension model for estimating the range based on the inputted text and question, and the determination unit determines the polarity of the answer to the question by using the determination model trained in advance to determine whether the polarity of the answer to the question is positive or not based on the information obtained by the processing of the machine comprehension unit.

As described above, the present invention can estimate the start and the end of the range serving as a basis for the answer to the question in the text by using the reading comprehension model for estimating the range based on the inputted text and question, and determine the polarity of the answer to the question by using the determination model trained in advance to determine whether the polarity of the answer to the question is positive or not based on information obtained by the processing of the estimation. This achieves an accurate answer with polarity to a question that can be answered with polarity.

The reading comprehension model and the determination model of the answer generating apparatus according to the present invention are neural networks. The machine comprehension unit can receive the text and the question as inputs, generate a reading comprehension matrix by using the reading comprehension model for estimating the range based on the result of encoding the text and the result of encoding the question, and estimate the start and the end of the range by using the reading comprehension matrix, and the determination unit can determine the polarity of the answer to the question by using the determination model for determining whether the polarity of the answer to the question is positive or not, based on the reading comprehension matrix generated by the machine comprehension unit.

The answer generating apparatus according to the present invention further includes a question determination unit that determines whether the question is capable of being answered with polarity. The determination unit can determine the polarity of the answer to the question by using the determination model, when the question determination unit determines that the question is capable of being answered with polarity.

According to the answer generating apparatus of the present invention, the polarity of the answer is Yes or No or OK or NG.

The answer generator according to the present invention further includes an output unit. The machine comprehension unit includes a basis extraction unit that extracts, based on information obtained by the processing, basis information on the answer to the question by using an extraction model for extracting the basis information serving as a basis for the answer to the question. The output unit can output, as an answer, the polarity of the answer and the basis information extracted by the basis extraction unit, the polarity being determined by the determination unit.

According to the answer generating apparatus of the present invention, the determination model is provided to determine whether the answer to the question has positive polarity, has polarity other than positive polarity, or has no polarity. The determination unit can determine whether the answer to the question has positive polarity, polarity other than positive polarity, or no polarity by using the determination model. The output unit can output, as an answer, the basis information extracted by the basis extraction unit, when the determination unit determines that the answer has no polarity.

An answer learning apparatus according to the present invention includes: an input unit that receives the inputs of text, a question, a correct answer indicating the polarity of an answer to the question in the text, and learning data including the start and the end of a range serving as a basis for the answer in the text; a machine comprehension unit that estimates the start and the end of the range by using a reading comprehension model for estimating the range based on the text and the question; a determination unit that determines the polarity of the answer to the question by using a determination model for determining whether the polarity of the answer to the question is positive or not based on information obtained by the processing of the machine comprehension unit; and a parameter learning unit that learns the parameters of the reading comprehension model and the determination model such that the correct answer included in the learning data agrees with the determination result of the determination unit and the start and the end in the learning data agree with the start and the end that are estimated by the machine comprehension unit.

An answer learning method according to the present invention includes: the method in which the input unit receives the inputs of text, a question, a correct answer indicating the polarity of an answer to the question in the text, and learning data including the start and the end of a range serving as a basis for the answer in the text; the machine comprehension unit estimates the start and the end of the range by using the reading comprehension model for estimating the range based on the text and the question; the determination unit determines the polarity of the answer to the question by using the determination model for determining whether the polarity of the answer to the question is positive or not based on information obtained by the processing of the machine comprehension unit; and the parameter learning unit learns the parameters of the reading comprehension model and the determination model such that the correct answer included in the learning data agrees with the determination result of the determination unit and the start and the end in the learning data agree with the start and the end that are estimated by the machine comprehension unit.

According to the answer learning apparatus and the answer learning method of the present invention, the input unit receives the inputs of the text, the question, the correct answer indicating the polarity of an answer to the question in the text, and the learning data including the start and the end of the range serving as a basis for the answer in the text, and the machine comprehension unit estimates the start and the end of the range by using the reading comprehension model for estimating the range based on the text and the question.

The determination unit determines the polarity of the answer to the question by using the determination model for determining whether the polarity of the answer to the question is positive or not based on the information obtained by the processing of the machine comprehension unit, and the parameter learning unit learns the parameters of the reading comprehension model and the determination model such that the correct answer included in the learning data agrees with the determination result of the determination unit and the start and the end in the learning data agree with the start and the end that are estimated by the machine comprehension unit.

As described above, the answer learning apparatus and the answer learning method receive the inputs of the text, the question, the correct answer indicating the polarity of an answer to the question in the text, and the learning data including the start and the end of the range serving as a basis for the answer in the text, and determine the polarity of the answer to the question by using the determination model for determining whether the polarity of the answer to the question is positive or not based on the information obtained by the process to estimate the start and the end of the range by using the reading comprehension model for estimating the range based on the text and the question. The parameters of the reading comprehension model and the determination model are trained such that the correct answer included in the learning data agrees with the determination result and the start and the end in the learning data agree with the estimated start and end, achieving a model for making an accurate answer with polarity to a question that can be answered with polarity.

The machine comprehension unit of the answer learning apparatus according to the present invention includes the basis extraction unit that extracts, based on information obtained by the processing, basis information on the answer to the question by using the extraction model for extracting the basis information serving as a basis for the answer to the question, the learning data further includes the basis information on the answer in the text, and the parameter learning unit can learn the parameter of the extraction model such that basis information on the answer in the text included in the learning data agrees with basis information extracted by the basis extraction unit.

A program according to the present invention is a program for functioning computer as each unit of the answer learning apparatus or the answer generating apparatus.

### Effects of the Invention

The answer generating apparatus, the answer generating method, and the program according to the present invention can make an accurate answer with polarity to a question that can be answered with polarity.

The answer generating apparatus, the answer generating method, and the program according to the present invention can learn a model for making an accurate answer with polarity to a question that can be answered with polarity.

### BRIEF DESCRIPTION OF DRAWINGS

FIG. 1 is a functional block diagram illustrating the configuration of an answer learning apparatus according to a first embodiment of the present invention.

FIG. 2 is a flowchart showing the answer learning routine of the answer learning apparatus according to the first embodiment of the present invention.

FIG. 3 is a functional block diagram illustrating the configuration of an answer generating apparatus according to the first embodiment of the present invention.

FIG. 4 is a flowchart showing the answer generation routine of the answer generating apparatus according to the first embodiment of the present invention.

FIG. 5 is a functional block diagram illustrating the configuration of an answer learning apparatus according to a second embodiment of the present invention.

FIG. 6 is a flowchart showing the answer learning routine of the answer learning apparatus according to the second embodiment of the present invention.

FIG. 7 is a flowchart showing the basis information extraction routine of the answer learning apparatus according to the second embodiment of the present invention.

FIG. 8 is a functional block diagram illustrating the configuration of an answer generating apparatus according to the second embodiment of the present invention.

FIG. 9 is a flowchart showing the answer generation routine of the answer generating apparatus according to the second embodiment of the present invention.

FIG. 10 illustrates an example of the baseline model of the answer generating apparatus according to the second embodiment of the present invention.

FIG. 11 illustrates a configuration example of the extraction model of a basis extraction unit according to the second embodiment of the present invention.

### DESCRIPTION OF EMBODIMENTS

Embodiments of the present invention will be described below in accordance with the accompanying drawings.

### <The Outline of an Answer Learning Apparatus According to a First Embodiment of the Present Invention>

As a new task setting for outputting an answer in a format unwritten in a text in response to an inputted question, the first embodiment of the present invention proposes a task “an answer is made with polarity of, for example, Yes or No to a question that can be answered with polarity of, for example, Yes or No.” The present embodiment will describe an example of an answer with polarity of Yes or No. The task for answering with Yes or No is a completely new task in existing researches.

Typical machine-comprehension data sets include MS-MARCO (Reference 1) in addition to SQuAD (Non Patent Literature 2). MS-MARCO is a data set for a human-generated answer from nearly ten paragraphs associated with a question. Such a task for outputting an answer in a format unwritten in a text in response to a question will be referred to as an abstractive task.
[Reference 1] Tri Nguyen, Mir Rosenberg, Xia Song, Jianfeng Gao, Saurabh Tiwary, Rangan Majumder, Li Deng, “MS MARCO: A Human Generated MAchine Reading COmprehension Dataset”, 2016.

Although two kinds of extractive and abstractive tasks are available, extractive tasks are set for many existing techniques of machine comprehension.

An abstractive task features “an answer is outputted in a format unwritten in a text” and thus is more difficult than an extractive task.

In an abstractive task, a data set for a correct answer human-generated from 0 is used, requiring an answer machine-generated from 0. A technique for an abstractive task is S-Net (Reference 2).
[Reference 2] Chuanqi Tan, Furu Weiz, Nan Yang, Bowen Du, Weifeng Lv, Ming Zhouz, “S-NET: FROM ANSWER EXTRACTION TO ANSWER GENERATION FOR MACHINE READING COMPREHENSION”, 2017.

In ordinary question and answers, answers with Yes or No are frequently required. In the use of the abstractive technique according to Reference 2, however, an answer of Yes or No may be generated but the probability is quite low, resulting in an incorrect answer.

The present embodiment proposes a technique specific to a task “a question that can be answered with Yes or No is answered with Yes or No”, achieving a correct answer in a state where a question is to be answered with Yes or No. This can considerably increase the range of machine answers.

An answer learning apparatus according to the present embodiment transforms a text P and a question Q as word sequences into vector sequences. A machine comprehension unit transforms the word sequences into an answer range score (s_{d}:sₑ) according to a reading technique. The answer learning apparatus transforms the vector sequence and the answer range score into a determination score by using a determination unit, which is a new technique, and performs learning by using the answer range score and the determination score.

Specifically, instead of making a binary determination of Yes or No (a determination by simple machine learning using the overall text P as a feature amount), the answer learning apparatus identifies the location of an answer to the question Q according to a machine comprehension technique and determines Yes or No based on the location.

At this point, the neural network of the machine comprehension unit and the determination unit includes shared layers, achieving learning from both sides of Yes/No determination based on machine comprehension and reading for Yes/No determination.

### <The Configuration of the Answer Learning Apparatus According to the First Embodiment of the Present Invention>

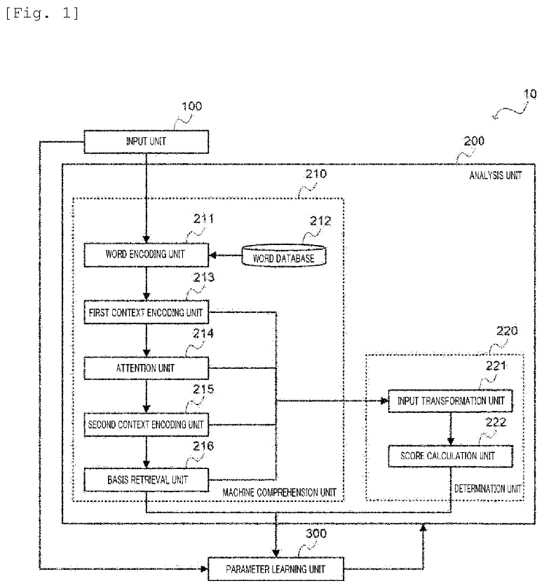

Referring to FIG. 1, the configuration of an answer learning apparatus 10 according to the first embodiment of the present invention will be described below. FIG. 1 is a block diagram illustrating the configuration of the answer learning apparatus 10 according to the first embodiment of the present invention.

The answer learning apparatus 10 includes a computer provided with a CPU, RAM, and ROM for storing a program for executing an answer learning routine, which will be described later. The function of the answer learning apparatus 10 is configured as will be described below. As illustrated in FIG. 1, the answer learning apparatus 10 according to the present embodiment includes an input unit 100, an analysis unit 200, and a parameter learning unit 300.

The input unit 100 receives the inputs of the text P, the question Q, a correct answer Y indicating the polarity of an answer to the question in the text P, and a plurality of learning data segments including a start D and an end E of a range serving as a basis for the answer in the text P.

Specifically, the learning data segments include the text P and the question Q that include text data, the correct answer Y that indicates whether the answer is Yes or No, and the range (D:E) serving as a basis for the answer in the text P. In this case, D and E are expressed by word position numbers in the text P. D is the position number of a word at the start position of the range serving as a basis for the answer and E is the position of a word at the end position of the range serving as a basis for the answer.

The text P and the question Q are text data expressed as token sequences by an existing tokenizer. A token may be expressed in any unit. In the present embodiment, the unit of a token is a word.

The lengths of the text P and the question Q as word sequences are defined by the number of words. The number of words in the text P is denoted as L_{P} and the number of words in the question Q is denoted as L_{Q}.

In the transformation of text data, the learning data segments may be collectively processed in mini batches or the learning data segments may be processed one by one.

Subsequently, the input unit 100 delivers the text P and the question Q to the machine comprehension unit 210 and delivers the learning data segments to the parameter learning unit 300 among the received learning data segments.

The analysis unit 200 includes the machine comprehension unit 210 and a determination unit 220.

The machine comprehension unit 210 estimates a start s_{d} and an end sₑ of a range D:E based on the text P and the question Q by using a reading comprehension model for estimating the range D:E serving as a basis for an answer in the text P.

Specifically, the machine comprehension unit 210 includes a word encoding unit 211, a word database (DB) 212, a first context encoding unit 213, an attention unit 214, a second context encoding unit 215, and a basis retrieval unit 216.

The word encoding unit 211 generates sequences P₁ and Q₁ of word vectors based on the text P and the question Q.

Specifically, the word encoding unit 211 extracts vectors for the words of the text P and the question Q from the word DB 212 and generates the sequences P₁ and Q₁ of the word vectors.

If vectors are stored with a dimension d in the word DB 212, the sequence P₁ of word vectors is a matrix with a size of L_{P}×d and the sequence Q₁ of word vectors is a matrix with a size of L_{Q}×d.

The word encoding unit 211 then transfers the generated sequences P₁ and Q₁ of word vectors to the first context encoding unit 213.

A plurality of word vectors are stored in the word DB 212. The word vectors are a set of real-valued vectors of a predetermined dimension indicating words.

Specifically, the word DB 212 uses a plurality of word vectors (word embedding) that are learned in advance by a neural network. The word vectors may include, for example, existing vectors such as word2vec and GloVe. The word vectors may be extracted from existing word vectors and linked to newly learned word vectors. An word embedding technique, for example, a technique for encoding character information on words (Reference 3) may be used. The word vectors can be also learned from gradients that can be calculated by error back-propagation.
[Reference 3] Yoon Kim, Yacine Jernite, David Sontag, Alexander M. Rush, “Character-Aware Neural Language Models”, arXiv:1508.06615, 2016.

The first context encoding unit 213 transforms the sequences P₁ and Q₁ of word vectors, which are generated by the word encoding unit 211, into vector sequences P₂ and Q₂, respectively, by using the neural network.

Specifically, the first context encoding unit 213 transforms the sequences P₁ and Q₁ of word vectors into the vector sequences P₂ and Q₂, respectively, by using an RNN. For the structure of the RNN, an existing technique, e.g., LSTM may be used.

In the present embodiment, the first context encoding unit 213 uses a bidirectional RNN that is a combination of an RNN for forward processing of the vector sequences and an RNN for backward processing of the vector sequences. If vectors are outputted with a dimension di by the bidirectional RNN, the vector sequence P₂ transformed by the first context encoding unit 213 is a matrix with a size of L_{F}×d₁ and the vector sequence Q₂ is a matrix with a size of L×di.

The first context encoding unit 213 delivers the transformed vector sequences P₂ and Q₂ to the attention unit 214 and delivers the vector sequence Q₂ to an input transformation unit 221.

The attention unit 214 generates a reading comprehension matrix B, which is a vector sequence indicating the attention of the text P and the question Q, based on the vector sequences P₂ and Q₂ by using a neural network.

Specifically, from the vector sequences P₂ and Q₂, the attention unit 214 first calculates an attention matrix below:

A∈ [symbol] ^{L}^{ₚ}^{×L}^{_{Q}}

For example, an attention matrix A can be calculated by Expression (1):

[Formula 1]

Aᵢⱼ=[P_{2,i:},Q_{2,j:},P_{2,i:}∘Q_{2,j:}]w_{S} (1)

where subscripts in the matrix indicate components and “:” indicates the overall matrix. For example, A_{i:} indicates the overall i-th row of the attention matrix A. Moreover, in Expression (1), “o” is an element product and “,” is an operator for vertically joining a vector and a matrix. wₛ is a trainable model parameter expressed as below:

wₛ∈ [symbol] ^{3d}^{₁}.

In a direction from the text P to the question Q based on the attention matrix, the attention unit 214 calculates an action vector below:

\tilde{Q}

In a direction from the question Q to the text P based on the attention matrix, the attention unit 214 calculates an action vector below:

\tilde{p}

Expression (2) can express the action vector:

\tilde{Q}

$$\begin{matrix}[ Formula 2 ] & \\ {α}_{i} = softmax ( {A}_{i :} ) ∈ {ℝ}^{{L}_{Q}} \\ {\tilde{Q}}_{i :} = {α}_{i , j} {Q}_{2 , j :} ∈ {ℝ}^{{d}_{1}} & ( 2 )\end{matrix}$$

where softmax is a softmax function expressed as below:

\tilde{Q}∈ [symbol] ^{L}^{_{P}}^{×d}^{₁}

Expression (3) can express the attention vector:

\tilde{p}

$$\begin{matrix}[ Formula 3 ] & \\ β = {softmax}_{i} ( {max}_{j} {A}_{ij} ) ∈ {ℝ}^{{L}_{P}} \\ \tilde{p} = {\sum }_{i} {β}_{i} {P}_{2 , i :} ∈ {ℝ}^{{d}_{1}} \\ where \\ {max}_{j} {A}_{ij} & ( 3 )\end{matrix}$$

is a vector of a L_{P} dimension and the i-th element (1≤i≤L_{P}) is the maximum value of the i-th vector of the attention matrix A (a maximum value in j direction). softmaxᵢ means the user of softmax in i direction.

β is determined as a vector with a length of L_{P} by using a max function for the attention matrix A. In Expression (3), the sum of weights in each row of P₂ is determined, the weights serving as the components of β. Thus, a length d₁ is expressed by the vector:

\tilde{p}

Moreover,

\tilde{p}^{T}

is repeatedly calculated L_{P} times to vertically obtain the matrix below:

\tilde{P}∈ [symbol] ^{L}^{_{P}}^{×d}^{₁}

Based on the vector sequences P₂, the action vector

\tilde{p}

and the action vector

\tilde{Q}

the attention unit 214 determines the reading comprehension matrix B with a length L_{P} expressing the result of attention. For example, the reading comprehension matrix is expressed as follows:

B=[P₂,\tilde{Q},P₂∘\tilde{Q},P₂∘\tilde{P}]∈ [symbol] ^{L}^{_{P}}^{×4d}^{₁}

where “,” is an operator for horizontally joining a vector and a matrix.

The attention unit 214 then delivers the reading comprehension matrix B to the input transformation unit 221 and the second context encoding unit 215.

The second context encoding unit 215 transforms the reading comprehension matrix B, which is generated by the attention unit 214, into a reading comprehension matrix M by using the neural network. The reading comprehension matrix M is a vector sequence.

Specifically, the second context encoding unit 215 transforms the reading comprehension matrix B into the reading comprehension matrix M by using an RNN. For the structure of the RNN, an existing technique, e.g., LSTM may be used as in the case of the first context encoding unit 213.

If word vectors are outputted with a dimension d₂ by the RNN of the second context encoding unit 215, the reading comprehension matrix is expressed as below:

M∈ [symbol] ^{L}^{ₚ}^{×d}^{₂}

The second context encoding unit 215 then delivers the transformed reading comprehension matrix M to the input transformation unit 221 and the basis retrieval unit 216.

The basis retrieval unit 216 estimates a start s_{d} and an end sₑ of a range D:E based on the reading comprehension matrix M by using the reading comprehension model for estimating the range D:E serving as a basis for an answer in the text P.

Specifically, the basis retrieval unit 216 includes two neural networks: a starting-end RNN for estimating the start s_{d} of the range serving as a basis for an answer and a terminal-end RNN for estimating the end sₑ.

The basis retrieval unit 216 first inputs the reading comprehension matrix M to the starting-end RNN and obtains a vector sequence M₁.

The basis retrieval unit 216 determines the start s_{d} of the range serving as a basis for an answer, according to Expression (4):

[Formula 4]

s_{d}=softnmax([B,M₁]w₁)∈ [symbol] ^{L}^{_{P}} (4)

where the start s_{d} is a score for the start of the range serving as a basis for an answer and is expressed by a vector. Specifically, the start s_{d} indicates a probability (score) that a word corresponding to each dimension of the vector is located at the start of an answer range.

Similarly, the reading comprehension matrix M is inputted to the terminal-end RNN and a word vector M₂ is obtained.

The basis retrieval unit 216 determines the end sₑ of the range serving as a basis for an answer, according to Expression (5):

[Formula 5]

sₑ=softmax([B,M₂]w₂)∈ [symbol] ^{L}_{P} (5)

where the end sₑ is a score for the end of the range serving as a basis for an answer and is expressed by a vector. Specifically, the end sₑ indicates a probability (score) that a word corresponding to each dimension of the vector is located at the end of the answer range.

The estimated start s_{d} and end sₑ will be collectively referred to as an answer range score. In Expressions (4) and (5), w₁ and w₂ are the parameters of reading comprehension models expressed in Expressions (4) and (5). The parameters can be learned.

The basis retrieval unit 216 then delivers the estimated answer range score to the input transformation unit 221 and the parameter learning unit 300.

Based on information obtained by the processing of the machine comprehension unit 210, the determination unit 220 determines the polarity of an answer to the question Q by using a determination model for determining whether the polarity of an answer to the question Q is positive or not.

Specifically, the determination unit 220 includes the input transformation unit 221 and a score calculation unit 222.

The input transformation unit 221 generates vector sequences P₃ and Q₃ based on the result of encoding of the text P by the machine comprehension unit 210 and the result of encoding of the question Q by the machine comprehension unit 210.

Specifically, the input transformation unit 221 first receives the input of information obtained by the processing of the machine comprehension unit 210.

The received information can be classified into four kinds of information. Specifically, the four kinds of information include: (1) a vector sequence (e.g., the reading comprehension matrix B or M) that is the encoding result of the text P and has a length L_{P} determined in consideration of the question Q, (2) a vector sequence (e.g., the vector sequence Q₂) that is the encoding result of the question Q and has a length L_{Q}, (3) a vector (e.g., the estimated start s_{d} and end sₑ) that is obtained as information on an answer range and has a length L_{P}, and (4) a matrix (e.g., the attention matrix A) that is the semantic matching result of the text P and the question Q with a size of L_{P}×L_{Q}.

In this case, it is not always necessary to receive the four kinds of information. The objective of the present embodiment can be attained as long as (1) is obtained as a minimum configuration (the reading comprehension matrix B or M). At least one of (2), (3), and (4) may be additionally received. In the example of the present embodiment, (1) the reading comprehension matrix B and (2) the vector sequence Q₂ are received as simple formats.

Based on the received reading comprehension matrix B and vector sequence Q₂, the input transformation unit 221 calculates the vector sequence having a length L_{P}:

P₃∈ [symbol] ^{L}^{_{P}}^{×d}^{₃}

and the vector sequence having a length L_{Q}:

Q₃∈ [symbol] ^{L}^{_{Q}}^{×d}^{₃}

In the method of calculating the vector sequences P₃ and Q₃, any neural network is usable. For example, Expressions (6) and (7) can be used.

[Formula 6]

P₃=RNN(B) (6)

Q₃=Q₂ (7)

Any number of dimensions can be set for d₃. When Expressions (6) and (7) are used, d₃=d₂ is set to match the dimension with that of Q₂ and the dimension of the output of an RNN in Expression (6) is also set at d₃=d₂.

The input transformation unit 221 then delivers the generated vector sequences P₃ and Q₃ to the score calculation unit 222.

The score calculation unit 222 determines the polarity of an answer to the question Q by using the determination model for determining whether the polarity of an answer to the question Q is positive or not.

Specifically, the score calculation unit 222 determines a determination score k (a real number from 0 to 1) used for classifying answers to the question Q into Yes or No, by using the framework of any sentence pair classification task based on the vector sequences P₃ and Q₃.

For example, a framework after decoder LSTM of ESIM (Reference 4) can be used for a problem of classification. ESIM is a typical model of implication recognition that is a sentence pair classification task.
[Reference 4] Qian Chen, Xiaodan Zhu, Zhenhua Ling, Si Wei, Hui Jiang, Diana Inkpen, “Enhanced LSTM for Natural Language Inference”, arXiv:1609.06038, 2017.

In this case, the vector sequences P₃ and Q₂ undergo average pooling (averaging in the column direction) or max pooling (determination of a maximum value in the column direction), so that vectors are obtained as follows:

Pₐ,Qₐ,Pₘ,Qₘ∈ [symbol] ^{d}^{₃}

The obtained vectors Vₐ, Qₐ, Pₘ, and Qₘ are joined to obtain a vector J with a dimension of 4d₃. The vector J is transformed to a real number (one-dimensional vector) by a multilayer perceptron and is subjected to sigmoid transformation to obtain a determination score k.

Yes/No classification may be classification into Yes, No, and unspecified. In this case, the vector J may be transformed to a three-dimensional vector by a multilayer perceptron and then may be subjected to softmax transformation to obtain the determination score k.

The score calculation unit 222 then delivers the determination score k to the parameter learning unit 300.

The parameter learning unit 300 learns the parameters of the reading comprehension model and the determination model such that the correct answer Y included in the learning data agrees with the determination result of the determination unit 220 and the start D and the end E in the learning data agree with the start sa and the end sₑ that are estimated by the machine comprehension unit 210.

Specifically, the parameter learning unit 300 determines, as the objective function of an optimization problem, the linear sum of an objective function L_{C} for the reading comprehension model used in the machine comprehension unit 210 and an objective function L_{J} for the determination model used in the determination unit 220 (Expression (8) below).

[Formula 7]

L_{C}+ΔL_{J} (8)

where λ is the parameter of the model and is learnable by a learning device. If the value of λ is specified in advance, a proper value, e.g., 1 or ½ is set to encourage learning.

The objective function L_{C} may be an objective function of any machine reading comprehension technique. For example, Non Patent Literature 1 proposes a cross-entropy function expressed in Expression (9) below:

[Formula 8]

L_{C}=logₛ_{_{d,D}}+logₛ_{_{e,E}} (9)

In Expression (9), D and E indicate the positions of a true start D and a true end E. s_{d,D} indicates the value of the D-th element in the vector S_{d}. s_{e,E} indicates the value of an E-th element in the vector sₑ.

The objective function L_{J} may be any objective function. For example, if a cross-entropy function is used, the objective function L_{J} is expressed by Expression (10) below:

[Formula 9]

L_{J}=log k_{Y} (10)

In Expression (10), Y is the correct answer Y indicating the polarity of a true answer. If the correct answer Y is Yes, score k_{Yes}=k is obtained. If the correct answer Y is No, score k_{No}=1−k is obtained. In other words, if the correct answer Y is Yes, L_{J}=log(k) is obtained. If the correct answer Y is No, L_{J}=log(1−k) is obtained.

The parameter leaning unit 300 then calculates the gradients of the objective functions in Expression (8) according to the backpropagation gradient method and updates the parameter according to any optimization technique.

### <The Operations of the Answer Learning Apparatus According to the First Embodiment of the Present Invention>

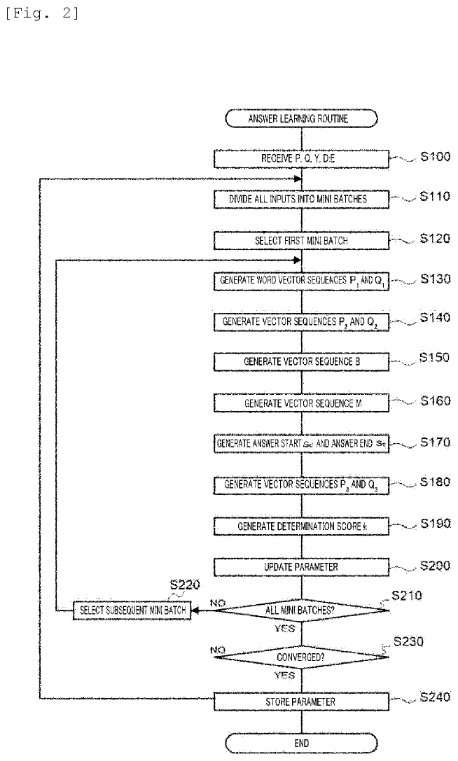

FIG. 2 is a flowchart showing an answer learning routine according to the first embodiment of the present invention. Learning in mini batches by the answer learning apparatus according to the present embodiment will be described below. A learning method for a typical neural network may be used instead. For convenience, it is assumed that the size of the mini batch is 1.

When multiple learning data segments are inputted to the input unit 100, the answer learning routine in FIG. 2 is executed in the answer learning apparatus 10.

In step S100, the input unit 100 first receives the inputs of the text P, the question Q, the correct answer Y indicating the polarity of an answer to the question in the text P, and the learning data segments including the start D and the end E of the range serving as a basis for the answer in the text P.

In step S110, the learning unit 100 divides the learning data received in step S100 into mini batches. The mini batches are E learning data sets that are obtained by randomly dividing the learning data segments. E is a natural number equal to or larger than 1.

In step S120, the word encoding unit 211 selects the first mini batch.

In step S130, the word encoding unit 211 generates the sequences P₁ and Q₁ of word vectors based on the text P and the question Q that are included in the selected mini batches.

In step S140, the first context encoding unit 213 transforms the sequences P₁ and Q₁ of word vectors, which are generated in step S130, into the vector sequences P₂ and Q₂, respectively, by using the neural network.

In step S150, the attention unit 214 generates the reading comprehension matrix B, which indicates the attention of the text P and the question Q, based on the vector sequences P₂ and Q₂ by using the neural network.

In step S160, the second context encoding unit 215 transforms the reading comprehension matrix B, which is generated in step S150, into the reading comprehension matrix M by using the neural network.

In step S170, the basis retrieval unit 216 estimates the start s_{d} and the end sₑ of the range D:E based on the reading comprehension matrix M by using the reading comprehension model for estimating the range D:E serving as a basis for an answer in the text P.

In step S180, the input transformation unit 221 generates the vector sequences P₃ and Q₃ based on the encoding result of the text P by the machine comprehension unit 210 and the encoding result of the question Q by the machine comprehension unit 210.

In step S190, the score calculation unit 222 determines the polarity of an answer to the question Q based on the vector sequences P₃ and Q₃ by using the determination model for determining whether the polarity of an answer to the question Q is positive or not.

In step S200, the parameter learning unit 300 updates the parameters of the reading comprehension model and the determination model such that the correct answer Y included in the learning data agrees with the determination result of the determination unit 220 and the start D and the end E in the learning data agree with the start s_{d} and the end sₑ that are estimated by the machine comprehension unit 210.

In step S210, the parameter learning unit 300 determines whether all the mini batches have been processed or not.

If all the mini batches have not been processed (No in step S210), the subsequent mini batch is selected in step S220 and then the process returns to step S130.

If all the mini batches have been processed (Yes in step S210), in step S230, the parameter learning unit 300 determines whether learning has been converged or not.

If learning has not been converged (No in step S230), the parameter learning unit 300 returns to step S110 and performs processing from steps S110 to S230 again.

If learning has been converged (Yes in step S230), the parameter learning unit 300 stores the learned parameters in memory (not illustrated) in step S240.

If the mini batch has a size of at least 2, the step of selecting the first text P and the first question Q may be added after step S120 and the step of determining whether all the sentences P and questions Q in the mini batches have been processed may be added before step S210. If the determination result is not positive, the subsequent text P and the subsequent question Q are selected and then the process returns to step S130. If the determination is positive, the process advances to step S210.

As described above, the answer learning apparatus according to the present embodiment receives the inputs of the text, the question, the correct answer indicating the polarity of an answer to the question in the text, and the learning data including the start and the end of the range serving as a basis for the answer in the text, and determines the polarity of the answer to the question by using the determination model for determining whether the polarity of the answer to the question is positive or not based on information obtained by estimating the start and the end of the range by using the reading comprehension model for estimating the range based on the text and the question. The parameters of the reading comprehension model and the determination model are trained such that the correct answer included in the learning data agrees with the determination result and the start and the end in the learning data agree with the estimated start and end, achieving a model for making an accurate answer with polarity to a question that can be answered with polarity.

### <The Configuration of the Answer Generating Apparatus According to the First Embodiment of the Present Invention>

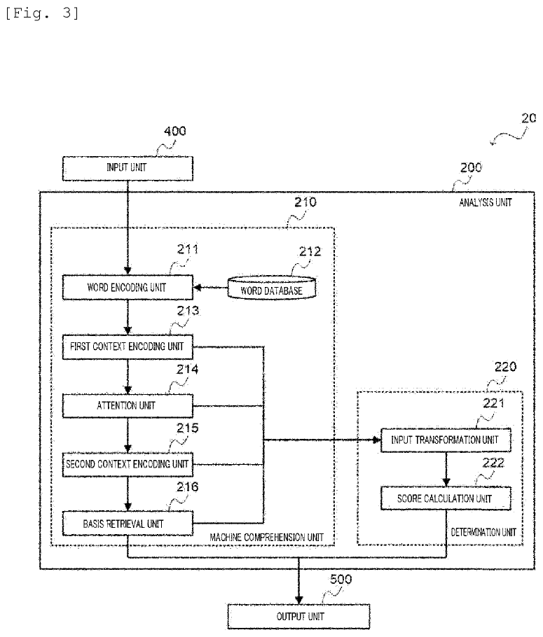

Referring to FIG. 3, the configuration of an answer generating apparatus 20 according to the first embodiment of the present invention will be described below. FIG. 3 is a block diagram illustrating the configuration of the answer learning apparatus 20 according to the first embodiment of the present invention. The same configurations as those of the answer learning apparatus 10 are indicated by the same reference numerals and a detailed explanation thereof is omitted.

The answer generating apparatus 20 includes a computer provided with a CPU, RAM, and ROM for storing a program for executing an answer generation routine, which will be described later. The function of the answer generator 20 is configured as will be described below. As illustrated in FIG. 3, the answer generator 20 according to the present embodiment includes an input unit 400, an analysis unit 200, and an input unit 500. The analysis unit 200 uses the parameters learned by the answer learning apparatus 10.

The input unit 400 receives the inputs of the text P and the question Q.

Subsequently, the input unit 400 delivers the received text P and question Q to the machine comprehension unit 210.

The output unit 500 determines, as a basis for an answer, an answer range score obtained by a basis retrieval unit 216 of a machine comprehension unit 210, and outputs, as an answer, a determination score k obtained by a score calculation unit 222 of a determination unit 220.

In this case, the output unit 500 can select any output format. For example, a determination result with a larger score is outputted as an answer from among the scores of Yes and No of the determination scores k or only a determination result with a score exceeding a threshold value is outputted.

Moreover, the output unit 500 can similarly select any output format for an answer range score. Since an answer range score includes the start s_{d} and end sₑ, various techniques can be used for a method of calculating an output. For example, as in Non Patent Literature 1, the output unit 500 can use a technique of outputting a string of words in a range where the product of the start s_{d} and the end sₑ is maximized under the constraint that the start s_{d} precedes the end sₑ.

### <The Operations of the Answer Generating Apparatus According to the First Embodiment of the Present Invention>

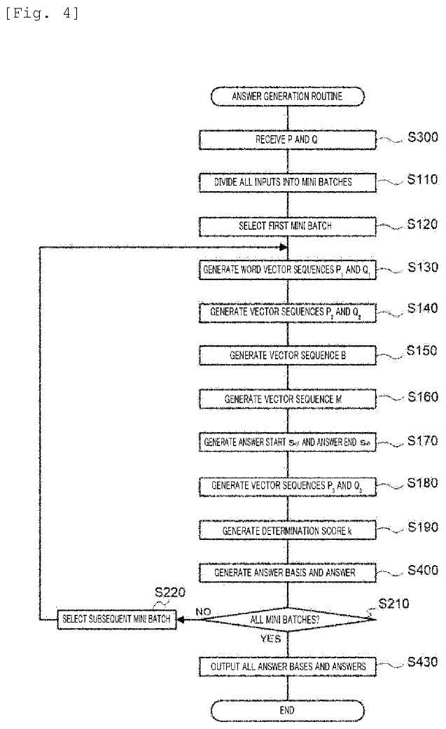

FIG. 4 is a flowchart showing an answer generation routine according to the first embodiment of the present invention. The same processing as that of the answer learning routine of the first embodiment is indicated by the same reference numerals and a detailed explanation thereof is omitted.

When the text P and the question Q are inputted to the input unit 400, the answer generation routine in FIG. 2 is executed in the answer generating apparatus 20.

In step S300, the input unit 400 receives the inputs of the text P and the question Q.

In step S400, the output unit 500 determines, as a basis for an answer, an answer range score obtained in step S170 according to a predetermined method and generates, as an answer, a determination score k obtained in step S190 according to a predetermined method.

In step S430, the output unit 500 outputs all bases for answers and answers which are obtained in step S400.

As described above, the answer generating apparatus according to the present embodiment determines the polarity of the answer to the question by using the determination model trained in advance to determine whether the polarity of the answer to the question is positive or not based on information obtained by estimating the start and the end of the range serving as a basis for the answer, by using the reading comprehension model for estimating the range based on the inputted text and question. This achieves an accurate answer with polarity to a question that can be answered with polarity.

### <The Outline of an Answer Learning Apparatus According to a Second Embodiment of the Present Invention>

When a human being who understands a natural language answers a question, an answer to the understood question can be estimated based on the experience, common sense, and universal knowledge of the human being. For example, in response to a question about a text read by a human being, an answer is found from not only the text but also his/her experience. In the case of an AI, however, it is necessary to estimate an answer only from information included in the text serving as the target of the question.

Regarding a question to be answered by Yes/No, in particular, knowledge for the answer of the question is not always described at a single point. For example, necessary knowledge may be described at multiple points in a text or may require additional universal knowledge. However, in consideration of a combination of descriptions at multiple points in the text and universal knowledge, it is necessary to understand the long-term dependence of the text. This make it difficult to make an accurate Yes/No answer to a question.

Thus, in order to accurately perform a task “an answer is made with Yes or No to a question that can be answered with Yes or No,” the second embodiment of the present invention focuses on a question including necessary knowledge written at multiple points in a text or a question to be answered with knowledge to be supplemented by universal knowledge. As in the first embodiment, the present embodiment will describe an example of an answer with polarity of Yes or No.

A question and an answer with a combination of descriptions at multiple points in a text are difficult because it is necessary to understand long-term dependence that is difficult for a neural network to understand. In the present embodiment, only a sentence necessary for an answer is extracted as a basis sentence. This allows matching between basis sentences separated from each other, leading to understanding of long-term dependence.

The extraction of the basis sentence allows a user to properly confirm not only a Yes/No answer but also a sentence serving as a basis for the answer, thereby improving interpretation.

Moreover, for a question and an answer that require knowledge to be supplemented with universal knowledge, a text including necessary information is retrieved from, for example, the Internet and then the question is answered for a new text connected to a sentence serving as the target of the question. Typically, in the simple connection of texts, matching is difficult because a part necessary for an answer in an original text is separated from a newly connected text. In the present embodiment, however, the necessary part and the newly connected text are extracted as basis sentences, enabling matching even if the basis sentences are separated from each other.

### <The Configuration of the Answer Learning Apparatus According to the Second Embodiment of the Present Invention>

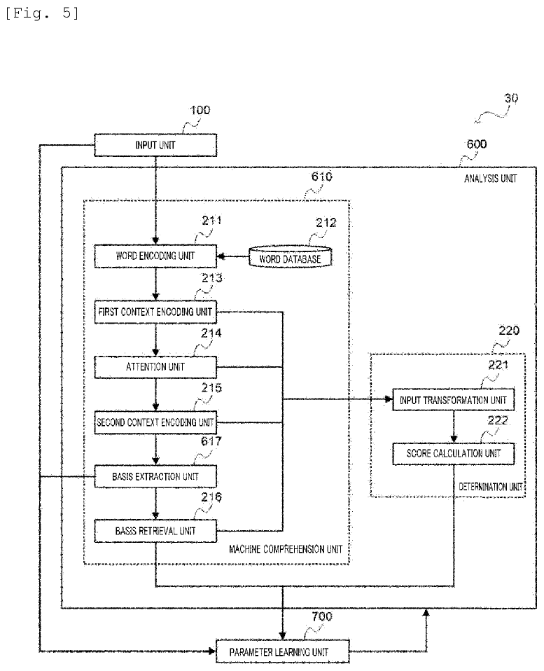

Referring to FIG. 5, the configuration of an answer learning apparatus 30 according to the second embodiment of the present invention will be described below. FIG. 5 is a block diagram illustrating the configuration of the answer learning apparatus 30 according to the second embodiment of the present invention. The same configurations as those of the answer learning apparatus 10 of the first embodiment are indicated by the same reference numerals and a detailed explanation thereof is omitted.

The answer learning apparatus 30 includes a computer provided with a CPU, RAM, and ROM for storing a program for executing an answer learning routine, which will be described later. The function of the answer learning apparatus 30 is configured as will be described below. As illustrated in FIG. 5, the answer learning apparatus 30 according to the present embodiment includes an input unit 100, an analysis unit 600, and a parameter learning unit 700.

The analysis unit 600 includes a machine comprehension unit 610 and a determination unit 220. The machine comprehension unit 610 estimates a start s_{d} and an end sₑ of a range D:E based on the text P and the question Q by using a reading comprehension model for estimating the range D:E serving as a basis for an answer in the text P.

Specifically, the machine comprehension unit 210 includes a word encoding unit 211, a word database (DB) 212, a first context encoding unit 213, an attention unit 214, a second context encoding unit 215, a basis extraction unit 617, and a basis retrieval unit 216.

The basis extraction unit 617 extracts basis information on an answer to the question Q by using an extraction model for extracting the basis information that is information serving as a basis for the answer to the question, based on information obtained by the processing of the machine comprehension unit 610.

Specifically, the basis extraction unit 617 first receives the reading comprehension matrix M (or the reading comprehension matrix B before transformation) that is transformed by the second context encoding unit 215, and extracts a vector sequence H, which indicates the meaning of each sentence in the text P, by using the neural network. The basis extraction unit 617 can use, for example, Undirectional-RNN as a neural network.

The basis extraction unit 617 then defines, as a time, an operation of extracting a basis sentence and generates a state zₜ by using the RNN of the extraction model. Specifically, the basis extraction unit 617 inputs the element of the vector sequence H, which corresponds to the basis sentence extracted at time t−1, to the RNN of the extraction model. The element of the vector sequence H is expressed as below:

hₛ_{_{t−1}}

Thus, the state zₜ is generated. sₜ is the subscript of the basis sentence extracted at time t−1. Furthermore, the set of sentences sₜ extracted before time t is denoted as sₜ.

The basis extraction unit 617 generates a glimpse vector eₜ (Expression (13)) by performing a glimpse operation (Reference 5) on the question Q according to the extraction model based on the state z and a vector sequence Y including a vector yⱼ for each word in the question. The glimpse vector eₜ is a question vector generated in consideration of significance at time t. As described above, the glimpse operation is performed on the question Q in the extraction model, so that the extraction result of the basis sentence can contain contents corresponding to the overall question.
[Reference 5] O. Vinyals, S. Bengio and M. Kudlur, “Order matters: Sequence to sequence for sets”, ICLR (2016).

$$\begin{matrix}[ Formula 10 ] & \\ {φ}_{j}^{t} = {v}_{g}^{⊤} tanh ( {W}_{g 1} {y}_{j} + {W}_{{g}^{2}} {z}_{t} ) & ( 11 ) \\ {φ}^{t} = softmax ( {a}^{t} ) ∈ {ℝ}^{n} & ( 12 ) \\ {e}_{t} = {\sum }_{j} {φ}_{j}^{t} {W}_{{g}^{t}} {y}_{j} ∈ {ℝ}^{d} & ( 13 )\end{matrix}$$

The initial value of the RNN of the extraction model is a vector that is obtained by manpooling on a vector sequence having been affine-transformed from the vector sequence H.

Based on the state zₜ, the glimpse vector eₜ, and the vector sequence H, the basis extraction unit 617 selects a δ-th sentence at time t by the extraction model according to a probability distribution expressed by Expression (14), and determines sentence sₜ=δ as a basis sentence extracted at time t.

$$\begin{matrix}[ Formula 11 ] & \\ P ( δ ; {S}_{t - 1} ) = {softmax}_{δ} ( {u}_{δ}^{t} ) \\ {u}_{j}^{t} = \{ \begin{matrix}{v}_{p}^{⊤} tanh ( {W}_{p 1} {h}_{j} + {W}_{p 2} {e}_{t} + {W}_{p 3} {z}_{t} ) & ( j ∉ {S}_{t - 1} ) \\ - ∞ & ( otherwise )\end{matrix} & ( 14 )\end{matrix}$$

The basis retrieval unit 617 then delivers the set S₁ of the extracted sentences sₜ as basis information to the basis retrieval unit 216 and the parameter learning unit 700.

The parameter learning unit 700 learns the parameters of the reading comprehension model, the determination model, and the extraction model such that the correct answer Y included in the learning data agrees with the determination result of the determination unit 220, the start D and the end E in the learning data agree with the start s_{d} and the end sₑ that are estimated by the machine comprehension unit 610, and information on a correct answer in the text P included in the learning data agrees with basis information extracted by the basis extraction unit 617.

Specifically, the parameter learning unit 700 determines, as the objective function of an optimization problem, the linear sum of an objective function L_{C} for the reading comprehension model used in the machine comprehension unit 610, an objective function L_{J} for the determination model used in the determination unit 220, and an objective function L_{S} for the extraction model used in the basis extraction unit 617 (Expression (15) below).

[Formula 12]

λ₁L_{C}+λ₂L_{J}+λ₃L_{S} (15)

where λ₁, λ₂, and λ₃ are hyperparameters. Proper values such as ⅓ are set to encourage learning. Moreover, teacher data varying among samples can be uniformly handled by setting 0 in λ of the term of absent data. For example, λ₁=0 is set for a sample that does not have data for the output of the basis retrieval unit 216.

The objective functions L_{C} and L_{J} are set as in the first embodiment. The objective function Lₛ is an objective function having been subjected to coverage regularization (Reference 6). For example, the objective function L; may be any objective function expressed by Expression (16).
[Reference 6] A. See, P. J. Liu and C. D. Manning, “Get to the point: summarization with pointer-generator networks”, ACL, 2017, pp. 1073-1083.

$$\begin{matrix}[ Formula 13 ] & \\ {L}_{S} = - {\sum }_{t = 1}^{T} log P ( {\hat{s}}_{t} ; {S}_{t - 1} ) + {\sum }_{i} min ( {c}_{i}^{t} , {φ}_{i}^{t} ) & ( 16 )\end{matrix}$$

In Expression (16),

ŝₜ

indicates a sentence s having a minimum extraction probability (δ;Sₜ₋₁) at time t in the set Sₜ of basis sentences provided as basis information on a correct answer, and c^{t} is a coverage vector expressed as below:

c^{t}=Σ_{T=1}^{t-}1φ^{T}

where t is a finish time. In other words, t=T is the condition for terminating learning. The coverage allows the extraction result to contain contents corresponding to the overall question. In order to learn the condition for terminating learning, as a learnable parameter, an extraction termination vector is provided as below:

h_{EOE}

The extraction termination vector

h_{EOE}

is added to the vector sequence H indicating the meaning of a sentence and m, the number of sentences in the text P, is set at an actual number of sentences+1. T is also set at a true number of basis sentences+1. During learning, all basis sentences are outputted before time T−1 and learning is performed to extract the extraction termination vector

h_{EOE}

at time T. During testing, extraction is terminated when the extraction termination vector is outputted.

The parameter leaning unit 700 then calculates the gradients of the objective functions in Expression (16) according to the backpropagation gradient method and updates the parameters according to any optimization technique.

### <The Operations of the Answer Learning Apparatus According to the Second Embodiment of the Present Invention>

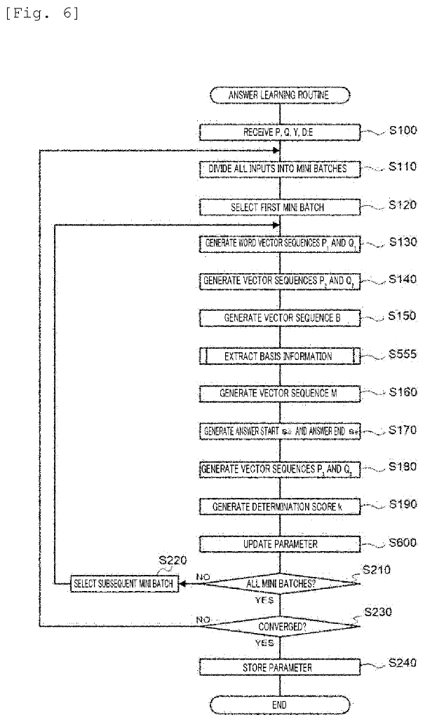

FIG. 6 is a flowchart showing an answer learning routine according to the second embodiment of the present invention. Learning in mini batches by the answer learning apparatus according to the present embodiment will be described below. A learning method for a typical neural network may be used instead. For convenience, it is assumed that the size of the mini batch is 1. The same configurations as those of the answer learning routine according to the first embodiment are indicated by the same reference numerals and a detailed explanation thereof is omitted.

In step S555, the basis extraction unit 617 extracts basis information.

In step S600, the parameter learning unit 700 learns the parameters of the reading comprehension model, the determination model, and the extraction model such that the correct answer Y included in the learning data agrees with the determination result of the determination unit 220, the start D and the end E in the learning data agree with the start s_{d} and the end sₑ that are estimated by the machine comprehension unit 210, and information on a correct answer in the text P included in the learning data agrees with basis information extracted by the basis extraction unit 617.

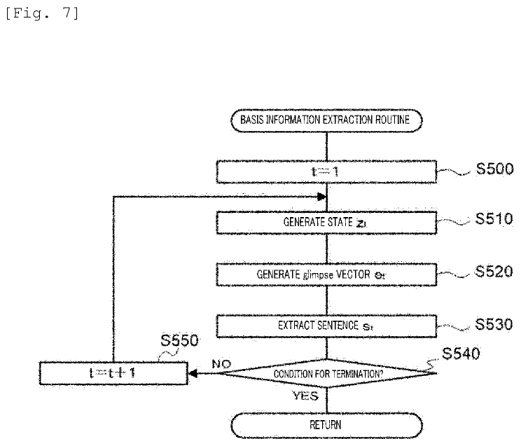

FIG. 7 is a flowchart showing a basis information extraction routine in the answer learning apparatus according to the second embodiment of the present invention. In the extraction of basis information, the basis extraction unit 617 extracts basis information on an answer to the question Q by using an extraction model for extracting the basis information that is information serving as a basis for the answer to the question, based on information obtained by the processing of the machine comprehension unit 610.

In step S500, the basis extraction unit 617 determines t=1.

In step S510, the basis extraction unit 617 defines, as a time, an operation of extracting a basis sentence and generates a state zₜ at time t by using the RNN of the extraction model.

In step S520, the basis extraction unit 617 generates a glimpse vector eₜ by performing a glimpse operation on the question Q. The glimpse vector eₜ is a question vector generated in consideration of significance at time t.

In step S530, the basis extraction unit 617 selects a δ-th sentence at time t according to the probability distribution expressed by Expression (14) and determines sentence sₜ=δ.

In step S540, the basis extraction unit 617 determines whether the condition for termination is satisfied or not.

If the condition for termination is not satisfied (No at step S540), the basis extraction unit 617 adds 1 to t in step S550, and then the process returns to step S510. If the condition for termination is satisfied (Yes at step S540), the basis extraction unit 617 returns.

As described above, based on information obtained by the processing of the machine comprehension unit, the answer learning apparatus according to the present embodiment extracts basis information on the answer to the question by using an extraction model for extracting the basis information that is information serving as a basis for the answer to the question, and learns the parameter of the extraction model such that basis information on an answer in text included in learning data agrees with basis information extracted by the basis extraction unit. This enables learning of a model for a more accurate answer with polarity to a question that can be answered with polarity.

### <The Configuration of an Answer Generating Apparatus According to the Second Embodiment of the Present Invention>

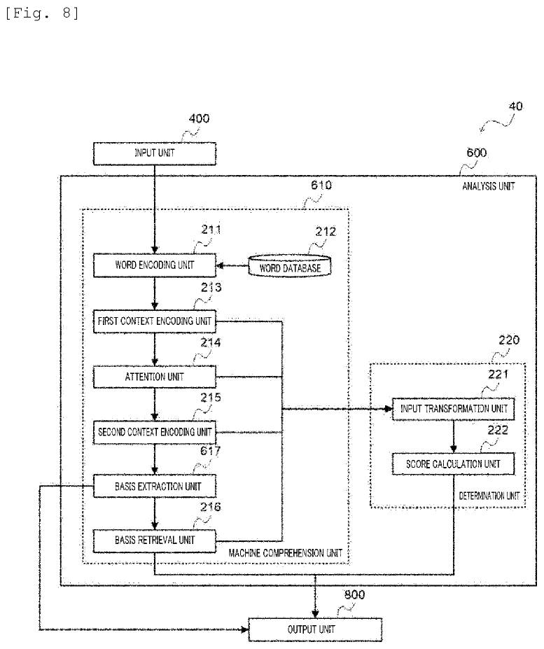

Referring to FIG. 8, the configuration of the answer generating apparatus 40 according to the second embodiment of the present invention will be described below. FIG. 8 is a block diagram illustrating the configuration of the answer generating apparatus 40 according to the second embodiment of the present invention. The same configurations as those of the answer learning apparatus 30 are indicated by the same reference numerals and a detailed explanation thereof is omitted. The answer generating apparatus 40 includes a computer provided with a CPU, RAM, and ROM for storing a program for executing an answer generation routine, which will be described later. The function of the answer generator 40 is configured as will be described below. As illustrated in FIG. 8, the answer generating apparatus 40 according to the second embodiment includes an input unit 400, an analysis unit 600, and an input unit 800.

The output unit 800 outputs, as an answer, the polarity of the answer and the basis information extracted by the basis extraction unit 617, the polarity being determined by the determination unit 220.

### <The Operations of the Answer Generating Apparatus According to the Second Embodiment of the Present Invention>

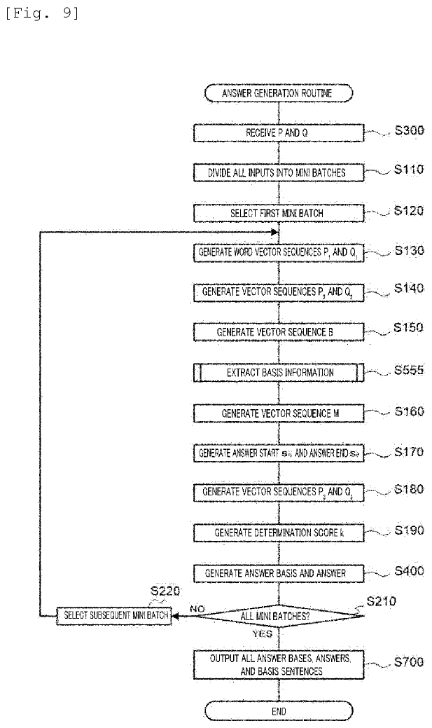

FIG. 9 is a flowchart showing the answer generation routine according to the second embodiment of the present invention. The same processing as that of the answer generation routine of the first embodiment and the answer generation routine according to the second embodiment is indicated by the same reference numerals and a detailed explanation thereof is omitted.

In step S700, the output unit 800 outputs all bases for answers and answers which are obtained in step S400 and the basis information obtained in step S555.

### <An Example of the Answer Generating Apparatus According to the Second Embodiment of the Present Invention>

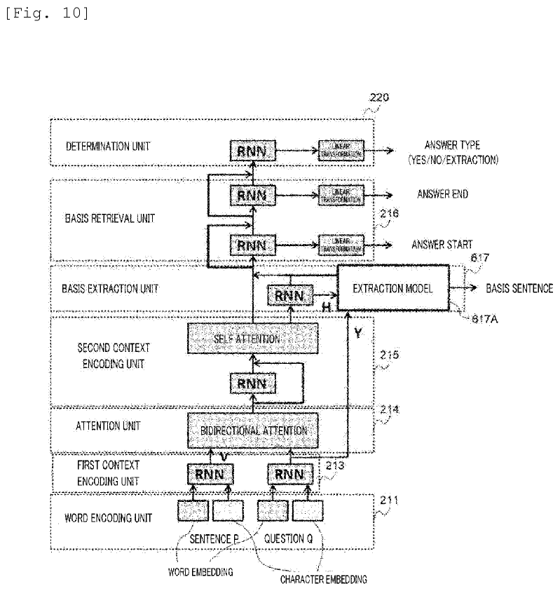

The example of the answer generating apparatus according to the second embodiment will be described below. In the present example, the units of the answer generating apparatus are configured as illustrated in FIG. 10. Specifically, the determination unit 220 is configured using an RNN and linear transformation, determines which one of Yes, No, and an extractive answer is to be replied, and outputs one of the three values of Yes, No, and an extractive answer. The basis retrieval unit 216 is configured using two sets of RNNs and linear transformation. One of the sets has an output at the endpoint of an answer, whereas the other set has an output at the starting point of the answer. The basis extraction unit 617 is configured using an RNN and an extraction model 617A. The second context encoding unit 215 is configured using an RNN and self-attention. The attention unit 214 is configured by bidirectional attention.

The first context encoding unit 213 is configured using two RNNs. The word encoding unit 211 is configured using two sets of word embedding and character embedding.

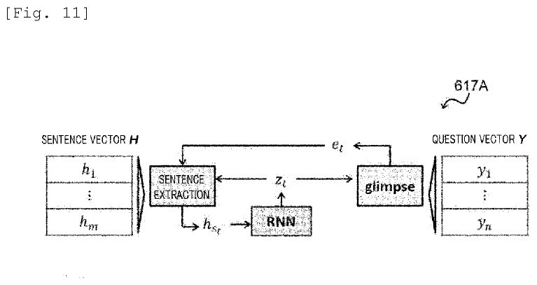

The extraction model 617A is configured as illustrated in FIG. 11. This configuration is based on an extractive text summarization model proposed in Reference 7.
[Reference 7] Y. C. Chen and M. Bansal, “Fast abstractive summarization with reinforce-selected sentence rewriting”, ACL, 2018, pp. 675-686.

In the technique of Reference 7, a sentence in summarization original text is extracted in consideration of the summarization original text. In the present example, a sentence in the text P is extracted in consideration of the question Q. In the extraction model 617A, a glimpse operation is performed on the question Q, so that the extraction result contains contents corresponding to the overall question.

### <An Experimental Result of the Example of the Answer Generating Apparatus According to the Second Embodiment of the Present Invention>

The experimental result of the example of the answer generating apparatus according to the second embodiment will be described below.

### <<Experimental Settings>>

An experiment was conducted using four pieces of “NVIDIA Tesla P100 (ELSA Japan Inc.)” for a GPU. Pytorch was used for implementation. The dimension of the output of Bi-RNN was standardized at d=300. The keep ratio of dropout was set at 0.8. The batch size was set at 72 and the learning rate was set at 0.001. Other settings are identical to those of a baseline model. The extraction model 617A initialized a vector according to a normal distribution and initialized a matrix according to a xavier normal distribution while using GRU for an RNN. The beam size was set at 2 during decoding.

As the baseline model, the extraction model 617A was changed to a model for obtaining the basis score of each sentence according to affine transformation and a sigmoid function in the configuration (FIG. 10) of the answer generating apparatus according to the example.

In the experiment, prediction accuracy was evaluated for an answer type T, an answer A, and a basis sentence S. In this case, the answer type T includes three labels, “Yes, No, extraction” in the task setting of HotpotQA. An exact match (EM) and a partial match were evaluated for an answer and basis sentence extraction. An index for a partial match is the harmonic mean (F1) of a relevance ratio and a recall ratio. The answer is evaluated by a match of the answer type T and the extraction is also evaluated by a match of the answer A. A partial match of the basis sentence extraction was measured by a match of a true basis sentence id of id of an extracted sentence. Thus, a partial match of a word is not taken into consideration. As for the answer type, the accuracy of an answer is denoted as YN only for “Yes/No” questions. Moreover, joint ME and joint F1 (Reference 8) are used as indexes in consideration of an answer and the accuracy of a basis.
[Reference 8] Z. Yang, P. Qi, S. Zhang, Y. Bengio, W. W. Cohen, R. Salakhutdinov and C. D. Manning, “HotpotQA: A dataset for diverse, explainable multi-hop question answering”, EMNLP, 2018, pp. 2369-2380.

The experiment is conducted for a distractor setting and a fullwiki setting. The distractor setting is made on the assumption that a large amount of text can be narrowed to a small amount of text about a question by an existing technique. The fullwiki setting is a setting for narrowing to a small amount of text by a TF-IDF similarity search.

### <<Experimental Result>>

As the experimental results of test data, Table 1 shows the result of the distractor setting and Table 2 shows the result of the fullwiki setting.

TABLE 1

| | Answer | | Basis | | Joint | |
|---|---|---|---|---|---|---|
| | EM | F1 | EM | F1 | EM | F1 |
| Base line | 45.6 | 59.0 | 20.3 | 64.5 | 10.8 | 40.2 |
| Proposed | 53.9 | 68.1 | 57.8 | 84.5 | 34.6 | 59.6 |
| technique | | | | | | |

TABLE 2

| | Answer | | Basis | | Joint | |
|---|---|---|---|---|---|---|
| | EM | F1 | EM | F1 | EM | F1 |
| Base line | 24.0 | 32.9 | 3.86 | 37.7 | 1.85 | 16.2 |
| Proposed | 28.7 | 38.1 | 14.2 | 44.4 | 8.69 | 23.1 |
| technique | | | | | | |

Both of the distractor setting and the fullwiki setting significantly exceed the baseline model in the example, achieving state-of-the-art accuracy. The exact matches of basis sentences, in particular, considerably increase to 37.5 points (+185%) in the distractor setting and to 10.3 points (+268%) in the fullwiki setting. Thus, the present example provides a technique of properly extracting a basis sentence. Table 3 shows the experimental result of development data in the distractor setting.

TABLE 3

| | Answer | | | Basis | | Joint | |
|---|---|---|---|---|---|---|---|
| | YN | EM | F1 | EM | F1 | EM | F1 |
| Base line | 57.8 | 52.7 | 67.3 | 34.3 | 78.0 | 19.9 | 54.4 |
| Proposed | 63.4 | 53.7 | 68.7 | 58.8 | 84.7 | 35.4 | 60.6 |
| technique | | | | | | | |
| −glimpse | 61.7 | 53.1 | 67.9 | 58.4 | 84.3 | 34.8 | 59.6 |

The baseline model of the development data was trained by our additional experiment and thus the accuracy of the model is considerably different from the numeric value of test data. This results from a difference among the hyperparameters. First, EM in the extraction of a basis sentence in the present example exceeds that of the baseline model by 24.5 points. F1 is also improved by 6.7 points. Furthermore, also in the answer, EM is increased by 1.0 point and F1 is increased by 1.4 points. The accuracy of determination of “Yes/No” is particularly increased by 5.6 points. In the baseline model and the present example, identical models are used other than the extraction model 617A. However, the accuracy of determination of “Yes/No” improves, implying that multitask learning with the extraction model 617A can train the lower RNN so as to acquire a feature amount conducive to an answer. Hence, the accuracy improves also in the Joint index. As a comparative technique, a technique of extracting only a sentence with an RNN without a glimpse operation was experimented and it was confirmed that accuracy in all the indexes of the present example is higher than that of an RNN without a glimpse operation.

Table 4 shows the experimental result of development data in the fullwiki setting.

TABLE 4

| | Answer | | | Basis | | Joint | |
|---|---|---|---|---|---|---|---|
| | YN | EM | F1 | EM | F1 | EM | F1 |
| Base line | 59.2 | 28.5 | 38.2 | 7.87 | 45.2 | 4.77 | 22.8 |
| Proposed | 62.2 | 29.0 | 38.8 | 14.4 | 44.8 | 8.43 | 23.3 |
| technique | | | | | | | |
| −glimpse | 60.8 | 28.6 | 38.2 | 13.9 | 44.5 | 8.30 | 23.0 |

EM of a basis in the present example exceeds that of the baseline model by 6.5 points but F1 is lower than that of the baseline model. In the answer, EM is increased by 0.9 points and F1 is increased by 0.8 points. The accuracy of determination of “Yes/No” is particularly increased by 3.0 points. Thus, it can be understood that the extraction model 617A encourages the learning of the lower RNN. This improves the accuracy also in the Joint index. Moreover, it was confirmed that accuracy in all the indexes of the present example is higher than that of a technique that does not use a glimpse operation.

According to the results, the accuracy of searching a small amount of related text for a particularly necessary sentence was 84.7% in a partial match in the distractor setting, and the accuracy of determining “Yes/No” by using a necessary sentence was improved by 5.6%.

As described above, based on information obtained by the processing of the machine comprehension unit, the answer generating apparatus according to the present embodiment extracts basis information on the answer to the question by using the extraction model for extracting the basis information that is information serving as a basis for the answer to the question, and outputs the polarity of the determined answer and the extracted basis information as answers. This achieves a more accurate answer with polarity to a question that can be answered with polarity.

The present invention is not limited to the foregoing embodiments and can be modified or applied in various ways within the scope of the present invention.

According to the foregoing embodiments, the present invention generates the vector sequences P₃ and Q₃ based on the result of encoding of the text P by the machine comprehension unit 210 and the result of encoding of the question Q by the machine comprehension unit 210. Furthermore, the present invention may determine the polarity of an answer to the question Q by using the determination model for determining whether the polarity of an answer to the question Q is positive or negative while using, as an input, at least one of the start s_{d} and the end sₑ of the range serving as a basis for an answer, the start and end being estimated by the machine comprehension unit 210, or the attention matrix A indicating the relationship between the text P and the question Q.

In this case, the second context encoding unit 215 delivers the transformed reading comprehension matrix M to the input transformation unit 221 and the basis retrieval unit 216 delivers the estimated answer range score to the input transformation unit 221.

For example, as a method of calculating the vector sequence P₃, the input transformation unit 221 can use Expressions (17) and (18):

[Formula 14]

P₃=Linear(B)+M (17)

P₃=[B,s_{d},sₑ,] (18)

where Linear( ) indicates linear transformation.

For example, as a method of calculating the vector sequence Q₃, the input transformation unit 221 can use Expression (19):

$$\begin{matrix}[ Formula 15 ] & \\ {α}_{i} = softmax ( {A}_{i :} ) ∈ {ℝ}^{{L}_{Q}} \\ {\tilde{Q}}_{i :} = {\sum }_{j} {α}_{i , j} {Q}_{2 , j :} ∈ {ℝ}^{{d}_{1}} & ( 19 )\end{matrix}$$

The input transformation unit 221 may perform the same operation on an attention matrix A^{T} and the vector sequence P, use the obtained vector sequence as the vector sequence Q₃, or join the vector sequence Q₂ to the obtained vector sequence.

These variations allow the determination of necessary variables in the input transformation unit 221.

In order to address a problem specific to a task, the score calculation unit 222 may use a devised existing framework of a sentence pair classification task.

For example, the use of the ESIM framework can be devised as follows:

### <<Device 1>>

Since the text P is not a sentence, the sequence length L_{P} is longer than that of the sentence pair classification task. In order to address the problem, max pooling and average pooling are replaced with techniques for longer sequences.

Specifically, these operations can be replaced with a technique that uses the final state of the output of LSTM when the vector sequence Q₃ is inputted to LSTM or attentive

pooling (an operation for obtaining the Flinear transformation of the vector sequence P₃ or the estimated start S_{d} and end sₑ as weights).

### <<Device 2>>

As compared with the sentence pair classification task, the vector sequence P₃ to be classified in the embodiment tends to include a large amount of information on the question Q as well as information on the text P. Thus, the vector J may be determined by using only the vector sequence P₃ in the score calculation unit 222 without using the vector sequence Q₃.

In this case, (1) only the reading comprehension matrix B can be received as information by the input transformation unit 221. For transformation to the vector sequence P₃, Expressions (6) is used. At this point, J is defined as follows:

J=[Pₘ;Pₐ]∈ [symbol] ^{2d}^{₃}

The answer learning apparatus 10 may further include a question determination unit that determines whether the inputted question Q is “a question that can be answered with Yes or No”.

Conventional techniques including a rule base and determination by machine learning may be used for the determination method of the question determination unit. In this case, when the question determination unit determines that the question is not “a question that can be answered with Yes or No”, an output (Yes/No) is not provided from the determination unit 220. In other words, only an output from the machine comprehension unit 210 may be provided.

In this way, the question determination unit is provided so as to prevent an answer with Yes or No to a question that cannot be properly answered with Yes or No if the output of the determination unit 220 is a Yes/No binary output. Moreover, a question that cannot be properly answered with Yes or No can be excluded from learning data, achieving more appropriate learning.

In the case of a ternary output of Yes/No/unspecified from the determination unit 220, the meaning of “unspecified” is further clarified. In the absence of the question determination unit, “unspecified” means “a question that cannot be properly answered with Yes or No” or “unspecified (because a description as a basis for an answer is not found in the text P)”. The question determination unit can determine that “unspecified” means the latter.

Alternatively, the question determination unit can be provided in the answer generating apparatus 20. The answer generating apparatus 20 includes the question determination unit, thereby preventing an answer with Yes or No to a question that cannot be properly answered with Yes or No if the output of the determination unit 220 is a Yes/No binary output.

The example of the present embodiment described the use of the determination model for determining whether an answer is Yes or No. The present invention is not limited to this model. The determination model may determine which one of Yes, No, and an extracted answer is to be replied. In the case of an extractive answer, the output unit may output, as an extractive answer, a basis sentence outputted by the basis extraction unit 617 or the outputted range of a basis for an answer from the basis retrieval unit 216.

In the example of the foregoing embodiment, the polarity of the answer is Yes or No. The polarity is not limited to Yes or No and may be, for example, OK or NG.

In the present specification, the program is preinstalled in the embodiments. The provided program can be stored in a computer-readable recording medium.

### REFERENCE SIGNS LIST

10, 30 answer learning apparatus
20, 40 answer generating apparatus
100 input unit
200, 600 analysis unit
210, 610 machine comprehension unit
211 word encoding unit
213 first context encoding unit
214 attention unit
215 second context encoding unit
216 basis retrieval unit
220 determination unit
221 input transformation unit
222 score calculation unit
300, 700 parameter learning unit
400 input unit
500, 800 output unit
617 basis extraction unit

1. An answer generating apparatus comprising:
a machine recognizer configured to estimate estimates a start and an end of a range serving as a basis for an answer in text, by using a reading comprehension model trained in advance to estimate the range based on the inputted text and an inputted question; and
a determiner configured to determine polarity of the answer to the question by using a determination model trained in advance to determine whether the polarity of the answer to the question is positive or not based on information obtained by processing of the machine comprehension unit.

2. The answer generating apparatus according to claim 1,
wherein the reading comprehension model and the determination model are neural networks,
wherein the machine recognizer:
receives the text and the question as inputs,
generates a reading comprehension matrix by using the reading comprehension model for estimating the range based on a result of encoding the text and a result of encoding the question, and
estimates the start and the end of the range by using the reading comprehension matrix, and
wherein the determiner determines the polarity of the answer to the question by using the determination model for determining whether the polarity of the answer to the question is positive or not, based on the reading comprehension matrix generated by the machine recognizer.

3. The answer generating apparatus according to claim 1, further comprising:
a question determiner configured to determine whether the question is capable of being answered with polarity, wherein the determiner determines the polarity of the answer to the question by using the determination model when the question determiner determines that the question is capable of being answered with polarity.

4. The answer generating apparatus according to claim 1, wherein the polarity of the answer is one of:
Yes,
No,
OK, or
NG.

5. The answer generating apparatus according to claim 1,
wherein the machine recognizer includes:
a basis extractor configured to that extract, based on information obtained by the processing, basis information on the answer to the question by using an extraction model for extracting the basis information serving as a basis for the answer to the question, and
the apparatus further comprising:
a provider configured to output, as an answer, the polarity of the answer and the basis information extracted by the basis extractor, the polarity being determined by the determiner.

6. The answer generating apparatus according to claim 5, wherein the determination model is provided to determine whether the answer to the question has positive polarity, polarity other than positive polarity, or no polarity, the determines whether the answer to the question has positive polarity, polarity other than positive polarity, or no polarity by using the determination model, and the provider outputs, as an answer, the basis information extracted by the basis extractor when the determiner determines that the answer has no polarity.

7. An answer learning apparatus comprising:
a receiver configured to receive inputs of text, a question, a correct answer indicating polarity of an answer to the question in the text, and learning data including a start and an end of a range serving as a basis for the answer in the text;
a machine recognizer configured to estimate the start and the end of the range by using a reading comprehension model for estimating the range based on the text and the question;
a determiner configured to determine the polarity of the answer to the question by using a determination model for determining whether the polarity of the answer to the question is positive or not, based on information obtained by the processing of the machine recognizer; and
a parameter learner configured to learn parameters of the reading comprehension model and the determination model such that the correct answer included in the learning data agrees with a determination result of the determiner and the start and the end in the learning data agree with the start and the end that are estimated by the machine recognizer.

8. The answer learning apparatus according to claim 7,
wherein the machine recognizer includes a basis extractor that extracts, based on information obtained by the processing, basis information on the answer to the question by using an extraction model for extracting the basis information serving as a basis for the answer to the question,
wherein the learning data further includes the basis information on the answer in the text, and
wherein the parameter learner further learns a parameter of the extraction model such that the basis information on the answer in the text included in the learning data agrees with basis information extracted by the basis extractor.

9. A method for processing an answer, the method comprising:
estimating, by a machine recognizer, a start and an end of a range serving as a basis for an answer in text by using a reading comprehension model for estimating the range based on the inputted text and an inputted question; and
determining, by a determiner, polarity of the answer to the question by using a determination model trained in advance to determine whether the polarity of the answer to the question is positive or not based on information obtained by processing of the machine recognizer.

10. The method of claim 9, the method further comprising:
receiving, by a receiver, inputs of text, a question, a correct answer indicating polarity of an answer to the question in the text, and learning data including a start and an end of a range serving as a basis for the answer in the text;
estimating, by machine recognizer, the start and the end of the range by using a reading comprehension model for estimating the range based on the text and the question;
determining, by the determiner, the polarity of the answer to the question by using a determination model for determining whether the polarity of the answer to the question is positive or not based on information obtained by the processing of the machine recognizer; and
learning, by a parameter learner, parameters of the reading comprehension model and the determination model such that the correct answer included in the learning data agrees with a determination result of the determination unit and the start and the end in the learning data agree with the start and the end that are estimated by the machine recognizer.

11. (canceled)

12. The answer generating apparatus according to claim 2, further comprising:
a question determiner configured to determine whether the question is capable of being answered with polarity, wherein the determiner determines the polarity of the answer to the question by using the determination model when the question determiner determines that the question is capable of being answered with polarity.

13. The answer generating apparatus according to claim 2, wherein the polarity of the answer is one of:
Yes,
No,
OK, or
NG.

14. The answer generating apparatus according to claim 2, wherein the machine recognizer includes a basis extractor configured to that extract, based on information obtained by the processing, basis information on the answer to the question by using an extraction model for extracting the basis information serving as a basis for the answer to the question, and
the apparatus further comprising:
a provider configured to output, as an answer, the polarity of the answer and the basis information extracted by the basis extractor, the polarity being determined by the determiner.

15. The answer generating apparatus according to claim 3, wherein the machine recognizer includes a basis extractor configured to that extract, based on information obtained by the processing, basis information on the answer to the question by using an extraction model for extracting the basis information serving as a basis for the answer to the question, and
the apparatus further comprising:
a provider configured to output, as an answer, the polarity of the answer and the basis information extracted by the basis extractor, the polarity being determined by the determiner.

16. The answer generating apparatus according to claim 4, wherein the machine recognizer includes a basis extractor configured to that extract, based on information obtained by the processing, basis information on the answer to the question by using an extraction model for extracting the basis information serving as a basis for the answer to the question, and
the apparatus further comprising:
a provider configured to output, as an answer, the polarity of the answer and the basis information extracted by the basis extractor, the polarity being determined by the determiner.

17. The method of claim 9,
wherein the machine recognizer:
receives the text and the question as inputs,
generates a reading comprehension matrix by using the reading comprehension model for estimating the range based on a result of encoding the text and a result of encoding the question, and
estimates the start and the end of the range by using the reading comprehension matrix, and
wherein the determiner determines the polarity of the answer to the question by using the determination model for determining whether the polarity of the answer to the question is positive or not, based on the reading comprehension matrix generated by the machine recognizer.

18. The method of claim 9, determining, by a question determiner, whether the question is capable of being answered with polarity, wherein the determiner determines the polarity of the answer to the question by using the determination model when the question determiner determines that the question is capable of being answered with polarity.

19. The method of claim 9, wherein the polarity of the answer is one of:
Yes,
No,
OK, or
NG.

20. The method of claim 9, the method further comprising:
wherein the machine recognizer includes a basis extractor configured to that extract, based on information obtained by the processing, basis information on the answer to the question by using an extraction model for extracting the basis information serving as a basis for the answer to the question, and
the method further comprising:
providing, by a provider as an answer, the polarity of the answer and the basis information extracted by the basis extractor, the polarity being determined by the determiner.

21. The method of claim 20, wherein the determination model is provided to determine whether the answer to the question has positive polarity, polarity other than positive polarity, or no polarity, the determines whether the answer to the question has positive polarity, polarity other than positive polarity, or no polarity by using the determination model, and the provider outputs, as an answer, the basis information extracted by the basis extractor when the determiner determines that the answer has no polarity.
